(19) United States
(12) Patent Application Publication
(10) Pub. No.: US 2019/0068782 A1
(43) Pub. Date: Feb. 28, 2019

(54) ELECTRONIC DEVICE AND METHOD FOR DISPLAYING COMMUNICATION STATUS OF CONTACTS

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JUN WANG, Shenzhen (CN)

(21) Appl. No.: 15/785,436

(22) Filed: Oct. 17, 2017

(30) Foreign Application Priority Data
Aug. 24, 2017 (CN) 201710735486.7

(51) Int. Cl. H04M 3/42; H04M 1/2745; H04M 1/725

(52) U.S. Cl. CPC H04M 3/42374; H04M 1/72522; H04M 1/274516; H04M 1/274508

(57) ABSTRACT

A method for displaying information of at least one phonebook contact using an electronic device includes setting a status of a user of the electronic device and sending the set status to a server, which communicates with the electronic device. Then, information of at least one phonebook contact is acquired from the server, and the acquired information of the at least one contact is displayed on a display screen of the electronic device.

### CROSS-REFERENCE TO RELATED APPLICATIONS

This application claims priority to Chinese Patent Application No. 201710735486.7 filed on Aug. 24, 2017, the contents of which are incorporated by reference herein.

### FIELD

The subject matter herein generally relates to communication technology, and particularly to an electronic device and a method for displaying communication states of contacts of the electronic device.

### BACKGROUND

A user can call one contact by using an electronic device (e.g., smart phone). The electronic device may remind the user that the contact is busy now after calling. So the user cannot sure whether the contact is busy or not before making a call.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic diagram of one exemplary embodiment of an electronic device.

FIG. 2 is a block diagram of one exemplary embodiment of the electronic device including a displaying system.

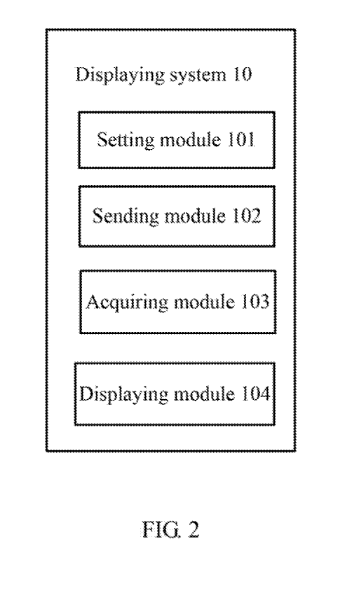

FIG. 3 illustrates a flow chart of an exemplary embodiment of a method for displaying status information of contacts using the electronic device of FIG. 1.

FIG. 4 illustrates a schematic diagram of an exemplary embodiment of a user interface for displaying status information of contacts.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

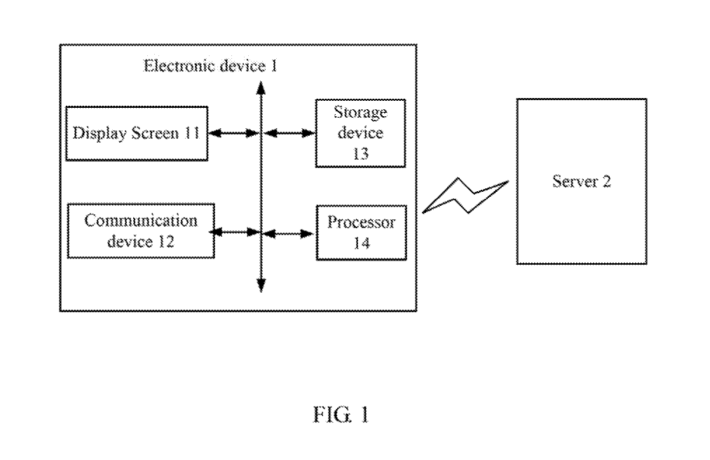

FIG. 1 is a block diagram of one embodiment of an electronic device 1. Depending on the embodiment, the electronic device 1 can include, but is not limited to, a display screen 11, a communication device 12, a storage device 13, and at least one processor 14. The above components communicate with each other through a system bus. In at least one embodiment, the electronic device 1 can be a smart phone, or any other suitable device. FIG. 1 illustrates only one example of the electronic device 1 that can include more or fewer components than illustrated, or have a different configuration of the various components in other embodiments.

In at least one exemplary embodiment, the display screen 11 can be a liquid crystal display (LCD) screen or an organic light-emitting diode (OLED) display screen. The display screen 11 can display a phonebook. The phonebook function is a phonebook list formed of texts. The phonebook list can include at least one contact. In present technology, the information of the at least one contact may include name, telephone number, work numbers, fax number, e-mail address and the like. In at least one exemplary embodiment, the information of the at least one contact may include status information of the contact and communication status of an electronic device of the contact. For example, the communication status of the electronic device of the contact can include, but is not limited to, a status of during a call, a status of power off, a status of out of prepaid credit, and a status of outside network. The status information of the contact can set by the contact herself/himself. For example, the contact can set the status information as busy when the contact has no time to answer a phone call.

In at least one exemplary embodiment, the electronic device 1 can connect to Internet through the communication device 12. The communication device 12 can communicate with any conventional wired network, wireless network and the both. The wired network can be any category of conventional wired communications, for example, the Internet, local area network (LAN). The wireless network can be any category of conventional wireless communications, for example, radio, Wireless Fidelity (WiFi), cellular, satellite, and broadcasting. Exemplary suitable wireless communication technologies include, but are not limited to, Global System for Mobile Communications (GSM), General Packet Radio Service (GPRS), Code Division Multiple Access (CDMA), Wideband CDMA (W-CDMA), CDMA2000, IMT Single Carrier, Enhanced Data Rates for GSM Evolution (EDGE), Long-Term Evolution (LTE), LTE Advanced, Time-Division LTE (TD-LTE), High Performance Radio Local Area Network (HiperLAN), High Performance Radio Wide Area Network (HiperWAN), High Performance Radio Metropolitan Area Network (HiperMAN), Local Multipoint Distribution Service (LMDS), Worldwide Interoperability for Microwave Access (WiMAX), ZigBee, Bluetooth, Flash Orthogonal Frequency-Division Multiplexing (Flash-OFDM), High Capacity Spatial Division Multiple Access (HC-SDMA), iBurst, Universal Mobile Telecommunications System (UMTS), UMTS Time-Division Duplexing (UMTS-TDD), Evolved High Speed Packet Access (HSPA+), Time Division Synchronous Code Division Multiple Access (TD-SCDMA), Evolution-Data Optimized (EV-DO), Digital Enhanced Cordless Telecommunications (DECT) and others.

In at least one exemplary embodiment, the electronic device 1 can communicate with a server 2 through the communication device 12. The server 2 can be a base station of a communication carrier. An electronic device of the contact can also communicate with the server 2. Thus, the electronic device 1 can communicate with an electronic device corresponding to one contact of the phonebook list.

In at least one exemplary embodiment, the storage device 13 can be a memory device of the electronic device 1. In other exemplary embodiments, the storage device 13 can be a secure digital card, or other external storage device such as a smart media card. In at least one exemplary embodiment, the storage device 13 can store a displaying system 10 of the electronic device 1.

The at least one processor 14 can be a central processing unit (CPU), a microprocessor, or other data processor chip that performs functions of the electronic device 1.

In at least one exemplary embodiment, the displaying system 10 can include a setting module 101, a sending module 102, an acquiring module 103, and a displaying module 104. The modules 101-104 include computerized codes in the form of one or more programs that may be stored in the storage device 13. The computerized codes include instructions that can be executed by the at least one processor 14.

In at least one exemplary embodiment, the setting module 101 can set status information of a user of the electronic device 1. The setting module 101 can supply a user interface for the user to input the status information. For example, the setting module 101 can set the status information as busy when the user of the electronic device 1 is busy and has no time to answer a phone call. The setting module 101 can set the status information as online when the user of the electronic device 1 is not busy. The setting module 101 can set the status information as offline when the user of the electronic device 1 is not busy but needs to be away from the electronic device 1 for a moment. Every contact of the contact list of the electronic device 1 can set the status information on her/his electronic device 1.

In at least one exemplary embodiment, the sending module 102 can send the set status information to the server 2. The sending module 102 can change a current communication status of the electronic device 1 to the set status information of the user, and send the set status information to the server 2. The server 2 can receive the set status information of the user and status information of every contact of the phonebook list.

In at least one exemplary embodiment, the acquiring module 103 can acquire information of the at least one contact from the server 2. The information of the at least one contact may include status information of the contact and communication status of an electronic device of the contact. The status information of the contact can include, but is not limited to, busy, online, and offline. The communication status of the electronic device of the contact can include, but is not limited to, a status of during a call, a status of power off, a status of out of prepaid credit, and a status of outside network.

In at least one exemplary embodiment, the contact himself/herself can set the status information of the contact. That is, the contact of the electronic device 1 and the user of the electronic device 1 can set the status information. When every contact of the contact list of the electronic device 1 sets the status information, the electronic device 1 of each contact can send the status information to the server 2. Then, the acquiring module 103 can acquire the status information of every contact from the server 2.

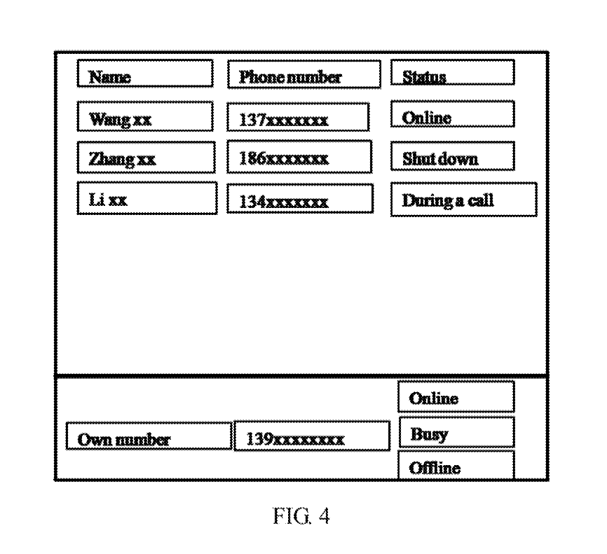

In at least one exemplary embodiment, the displaying module 104 can display the acquired information of the at least one contact on the display screen 11. In at least one exemplary embodiment, the displaying module 104 can display the status information of every contact or the communication status of the electronic device of the contact on the display screen 11, as shown in FIG. 4. The displaying module 104 can prompt the user to know the most appropriate time to call the contact.

In at least one exemplary embodiment, the priority of the communication status of the electronic device of the contact is higher than the status information of every contact. For example, when the user sets the status information as offline, but the user is making a call in an emergency, the sending module 102 can change the offline status to be during a call status.

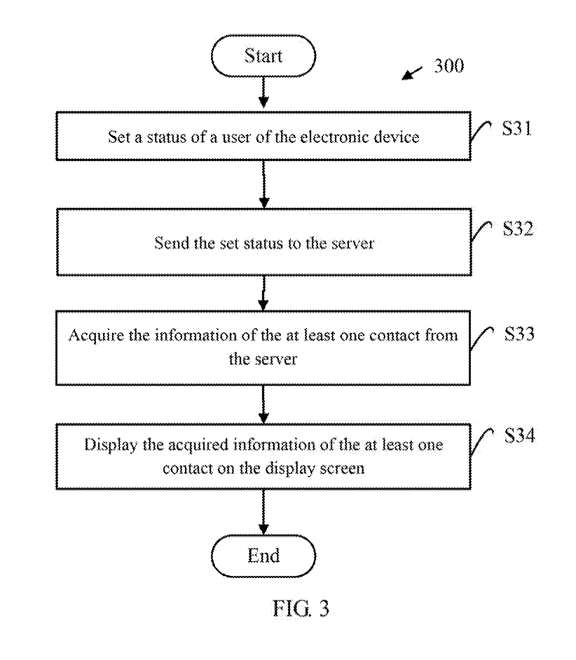

FIG. 3 illustrates a flowchart which is presented in accordance with an example embodiment. The exemplary method 300 is provided by way of example, as there are a variety of ways to carry out the method. The method 300 described below can be carried out using the configurations illustrated in FIG. 1, for example, and various elements of these figures are referenced in explaining exemplary method 300. Each block shown in FIG. 3 represents one or more processes, methods, or subroutines, carried out in the exemplary method 300. Additionally, the illustrated order of blocks is by example only and the order of the blocks can be changed according to the present disclosure. The exemplary method 300 can begin at block S31. Depending on the embodiment, additional steps can be added, others removed, and the ordering of the steps can be changed.

At block S31, the setting module 101 can set status information of a user of the electronic device 1. The setting module 101 can supply a user interface for the user to input the status information. For example, the setting module 101 can set the status information as busy when the user of the electronic device 1 is busy and has no time to answer a phone call. The setting module 101 can set the status information as online when the user of the electronic device 1 is not busy. The setting module 101 can set the status information as offline when the user of the electronic device 1 is not busy but needs to be away from the electronic device 1 for a moment. Every contact of the contact list of the electronic device 1 can set the status information on her/his electronic device 1.

At block S32, the sending module 102 can send the set status information to the server 2. The sending module 102 can change a current communication status of the electronic device 1 to the set status information of the user, and send the set status information to the server 2. The server 2 can receive the set status information of the user and status information of every contact of the phonebook list.

At block S33, the acquiring module 103 can acquire information of the at least one contact from the server 2. The information of the at least one contact may include status information of the contact and communication status of an electronic device of the contact. The status information of the contact can include, but is not limited to, busy, online, and offline. The communication status of the electronic device of the contact can include, but is not limited to, a status of during a call, a status of power off, a status of out of prepaid credit, and a status of outside network.

At block S34, the displaying module 104 can display the acquired information of the at least one contact on the display screen 11. In at least one exemplary embodiment, the displaying module 104 can display the status information of every contact or the communication status of the electronic device of the contact on the display screen 11, as shown in FIG. 4. The displaying module 104 can prompt the user to know the most appropriate time to call the contact.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

1. An electronic device comprising:
a display screen;
a storage device;
at least one processor,
wherein storage device stores one or more programs that, when executed by the at least one processor, cause the at least one processor to:
set a status of a user of the electronic device;
send the set status to a server which communicates with the electronic device;
acquire information of at least one contact of the electronic device from the server, wherein the acquired information of the at least one contact comprises the set status of the at least one contact and communication status of an electronic device of the at least one contact, and the set status of the at least one contact comprises busy, online and offline, and the communication status of an electronic device of the at least one contact comprises a status of during a call, a status of power off, a status of out of prepaid credit, and a status of outside network; and
display the acquired information of the at least one contact on the display screen.

2-3. (canceled)

4. The electronic device according to claim 1, wherein a priority of the communication status of the electronic device of the contact is higher than the set status of the at least one contact.

5. The electronic device according to claim 1, wherein the at least one processor is further caused to supply a user interface for the user to input the set status.

6. A displaying method applied in an electronic device, the electronic device communicates with a server, the method comprising:
setting a status of a user of the electronic device;
sending the set status to the server;
acquiring information of at least one contact of the electronic device from the server, wherein the acquired information of the at least one contact comprises the set status of the at least one contact and communication status of an electronic device of the at least one contact, and the set status of the at least one contact comprises busy, online and offline, and the communication status of an electronic device of the at least one contact comprises a status of during a call, a status of power off, a status of out of prepaid credit, and a status of outside network; and
displaying the acquired information of the at least one contact on a display screen of the electronic device.

7-8. (canceled)

9. The method according to claim 6, wherein a priority of the communication status of the electronic device of the contact is higher than the set status of the at least one contact.

10. The method according to claim 6, further comprising:
supplying a user interface for the user to input the set status.

11. A non-transitory storage medium having stored thereon instructions that, when executed by a processor of an electronic device, causes the processor to perform a displaying method, the electronic device communicates with a server, the method comprising:
setting a status of a user of the electronic device;
sending the set status to the server;
acquiring information of at least one contact of the electronic device from the server, wherein the acquired information of the at least one contact comprises the set status of the at least one contact and communication status of an electronic device of the at least one contact, and the set status of the at least one contact comprises busy, online and offline, and the communication status of an electronic device of the at least one contact comprises a status of during a call, a status of power off, a status of out of prepaid credit, and a status of outside network; and
displaying the acquired information of the at least one contact on a display screen of the electronic device.

12-13. (canceled)

14. The non-transitory storage medium according to claim 11, wherein a priority of the communication status of the electronic device of the contact is higher than the set status of the at least one contact.

15. The non-transitory storage medium according to claim 11, wherein the method further comprising:
supplying a user interface for the user to input the set status.
